(19) United States
(12) Patent Application Publication
(10) Pub. No.: US 2023/0153686 A1
(43) Pub. Date: May 18, 2023

(54) METHODS AND SYSTEMS FOR TRAINING A MACHINE LEARNING MODEL

(71) Applicant: THALES DIS FRANCE SAS, MEUDON (FR)

(72) Inventors: Adrian WALLER, Reading (GB); Naomi FARLEY, Reading (GB)

(73) Assignee: THALES DIS FRANCE SAS, MEUDON (FR)

(21) Appl. No.: 17/920,457

(22) PCT Filed: Apr. 23, 2021
(86) PCT No.: PCT/EP2021/060746

§ 371 Date: Oct. 21, 2022

(30) Foreign Application Priority Data
Apr. 24, 2020 (GB) 2006063.8

(51) Int. Cl. G06N 20/00

(52) U.S. Cl. CPC G06N 20/00

(57) ABSTRACT

A computer-implemented method for training a machine learning model, the method comprising: obtaining a machine learning model comprising a plurality of computational layers, the layers being arranged such that outputs from one or more of the layers serve as inputs to other ones of the layers; identifying one or more of the layers as comprising one or more functions that are not compatible with a homomorphic encryption scheme; replacing the one or more functions with alternative functions, wherein the alternative functions are functions that are compatible with the homomorphic encryption scheme and which provide an approximation of the respective functions that they replace; and sending the model to a third party to train the model using a set of training data.

### FIELD

Embodiments described herein relate to methods and systems for training of a machine learning model. In particular, but not-exclusively, embodiments relate to methods and systems for outsourcing training of machine learning models to third parties.

### BACKGROUND

In recent years, the use and development of machine learning algorithms has grown exponentially. Such algorithms enable computers to learn to perform tasks without the need to be explicitly programmed.

Machine learning algorithms include a diverse array of different types of model. These include Neural Networks (including Convolutional Neural Networks (CNNs), Recurrent Neural Networks (RNNs) and Long Short-Term Memory Networks (LSTMs)); Bayesian Networks, Support Vector Machines (SVM) and others. In each case, the machine learning algorithm is tasked with processing a set of data so as to generate some form of output. As an example, a CNN may be tasked with analysing an image, so as to determine a particular type of animal that is present in that image. The CNN may act as a classifier, by classifying the image as either an image of a dog or an image of a cat, for example.

In most cases, the machine learning algorithm comprises a number of distinct stages or steps. At each stage, a series of computations is carried out, with the results of those computations then being used as inputs to the next stage of computation. These stages can, in many cases, be visualised as a series of layers, with each layer being tasked with performing a particular type of computation using the results from the previous layer in the sequence. For example, in the case of a CNN, a first layer may comprise a convolution layer in which an input image is convolved with one or more filters or kernels. The convolution layer may be followed by a Rectified Linear Unit (ReLU) layer, which functions to replace negative values in the matrices output by the convolution layer with zeros. A pooling layer may then be implemented to reduce the number of matrix elements, and a Fully Connected Layer may be used to derive a classification of the image from the values returned by the pooling layer.

When feeding the results from a preceding layer into the next layer, a respective weighting may be applied to each input, such that certain inputs will have a greater impact on the output from the present layer than others. Once the current layer's computation is complete, the results of that computation will then serve as inputs into the next layer and so on.

In order for the machine learning algorithm to perform effectively, it will be necessary to train the algorithm. Training comprises providing the algorithm with a known set of data (training data) for which the correct output is already known and monitoring the error in the results output by the algorithm. Here, the error reflects the difference between the expected (correct) output for the training data and the actual answer that is output by the machine learning algorithm. For example, in the case of a CNN used to classify images of cats and dogs, the CNN may be provided with a set of images of cats and another set of images of dogs, with each image being labelled as “cat” or “dog”. The error will then reflect the extent to which the algorithm will classify an image of a cat as being one of a dog, and vice versa. The error may be determined through use of an appropriate loss function.

Measurement of the error provides feedback for updating internal parameters of the machine learning algorithm, the goal being to modify these parameters to reduce the error in the output. Among these parameters may be the weightings that are applied to the inputs to each layer and/or the values of constants/coefficients of functions executed within each layer of the network. The value of these parameters may be altered and the error in the output from the algorithm determined before revising the parameter values again. This process of determining the error and revising the parameter values accordingly may be carried out iteratively using an appropriate algorithm such as backpropagation. The process will be repeated a number of times, such as for a pre-determined set number or until such time as the error between the output from the algorithm and the expected results falls beneath a threshold. At this point, the algorithm is deemed to be “trained” and is ready to process new data (i.e. data not used during training), using the finalised set of parameter values.

In practice, training a machine learning algorithm can pose a number of challenges. First, the process can be computationally intensive, making it desirable to outsource training of the machine learning algorithm to a third party, such as a cloud server. However, due to the difficulty of constructing a ‘good’ model (e.g. one which will classify images or other data sets to a high degree of accuracy), the optimal values for the internal parameters of the model—as determined by the training process—may be considered sensitive. Outsourcing an unencrypted model to a cloud server for training may enable the cloud server to learn the (trained) sensitive values of those parameters, however.

A second problem is that the data (e.g. images) on which the model is to be trained may themselves be considered sensitive and so organizations may be hesitant to provide data for use in training the model unless that data is encrypted. Conventional machine learning models may not be compatible with training using encrypted data, however.

One technique aimed at solving some of these problems is Multi-Party Computation (MPC). MPC allows for a machine learning algorithm or model to be privately trained, but requires training to be carried out by multiple parties in an interactive manner. Thus, MPC has the drawback that it requires multiple parties to carry out training, and requires interaction during the training phase. Furthermore, the communication overhead of an MPC solution is often disadvantageous.

An alternative technique known as Federated Learning could also be considered. However, this approach only prevents entities from learning other entities' sensitive data and does not enable the model to be privately trained. Additionally, it requires training to be carried out by multiple entities and potentially in an interactive manner.

In accordance with the above, it is desirable to find ways to modify a machine learning model such that it may be trained by a (single) party using encrypted training data. A further goal is to provide a simplified means in which training can be outsourced to a third party, whilst still keeping the internal parameters of the model private. These problems are particularly acute in the case of CNNs, but are also present in the case of other types of machine learning algorithm.

The above questions are, moreover, not only relevant in terms of training the model, but are also relevant in terms of running the model once it has been trained. In the case of a CNN used to classify data, the classification phase may itself be outsourced to a third party. Here again, the owner of the model may wish to maintain the privacy of the internal parameter values when providing the model to that third party. In addition, as with the data sets used for training, the data sets on which classification is to be performed may themselves be encrypted; this could be true regardless of whether it is the model owner or a third party carrying out the classification phase. Thus, the model must be capable of handling and processing the encrypted data in the classification phase in the same way as in the training phase.

### SUMMARY

According to a first aspect of the present invention, there is provided a computer-implemented method for training a machine learning model, the method comprising:
obtaining a machine learning model comprising a plurality of computational layers, the layers being arranged such that outputs from one or more of the layers serve as inputs to other ones of the layers;
identifying one or more of the layers as comprising one or more functions that are not compatible with a homomorphic encryption scheme;
replacing the one or more functions with alternative functions, wherein the alternative functions are functions that are compatible with the homomorphic encryption scheme and which provide an approximation of the respective functions that they replace; and
sending the model to a third party to train the model using a set of training data.

The one or more functions that are not compatible with the HE scheme may include one or more of:
(i) A non-polynomial function;
(ii) A function including one or more conditional statements; and
(iii) A polynomial function that includes a non-integer and/or negative power.

The alternative functions may comprise polynomial functions whose powers are positive integers.

The method may further comprise encrypting internal parameters of the model with a public key of the homomorphic encryption scheme prior to sending the model to the third party.

The method may further comprise:
receiving a trained version of the machine learning model from the third party; and decrypting the internal parameters of the trained version of the machine learning model using the private key of the homomorphic encryption scheme.

The internal parameters of the model may comprise one or more of: (i) constants comprised within the functions of the model and (ii) weightings applied to input(s) to each layer of the model.

The training data may comprise encrypted data.

Sending the model to the third party may comprise transmitting the model as data over a communications network.

According to a second aspect of the present invention, there is provided a computer-implemented method for training a machine learning model, the method comprising:
obtaining a machine learning model comprising a plurality of computational layers, the layers being arranged such that outputs from one or more of the layers serve as inputs to other ones of the layers;
identifying one or more of the layers as comprising one or more functions that are not compatible with a homomorphic encryption scheme;
replacing the one or more functions with alternative functions, wherein the alternative functions are functions that are compatible with a homomorphic encryption scheme and which provide an approximation of the respective functions that they replace;
receiving encrypted training data for training the machine learning model;
and training the model using the training data.

The one or more functions that are not compatible with the HE scheme may include one or more of:
(i) A non-polynomial function;
(ii) A function including one or more conditional statements; and
(iii) A polynomial function that includes a non-integer and/or negative power.

The alternative functions may comprise polynomial functions whose powers are positive integers.

The training data may comprise data that is encrypted by a third party.

The method may further comprise using the trained machine leaning model to carry outa machine learning task.

The step of using the trained machine learning model to carry out the machine learning task may be performed by a third party.

The task may comprise classification of one or more images.

The machine learning model may be a neural network. The machine learning model may be a convolutional neural network.

Replacing the functions with alternative functions may include selection of an optimisation solver that is compatible with homomorphic encryption.

The functions to be replaced may comprise one or more functions having one or more division operations and/or which contain one or more square roots. The functions having one or more division operations and/or which contain one or more square roots may be replaced by using a Newton-Raphson method to approximate the square root(s) and/or divisions.

The functions to be replaced may comprise one or more exponential functions.

The exponential functions may be replaced by using a Taylor series approximation of the exponential function(s).

The method may comprise adding a batch normalisation layer before one or more of the layers whose functions have been replaced by alternative functions.

The functions to be replaced may include a loss function used in training the model.

The model may be trained using backpropagation.

According to a third aspect of the present invention, there is provided a computer readable medium comprising computer executable code that when executed by the computer will cause the computer to carry out a method according to either the first aspect or second aspect of the present invention.

### BRIEF DESCRIPTION OF DRAWINGS

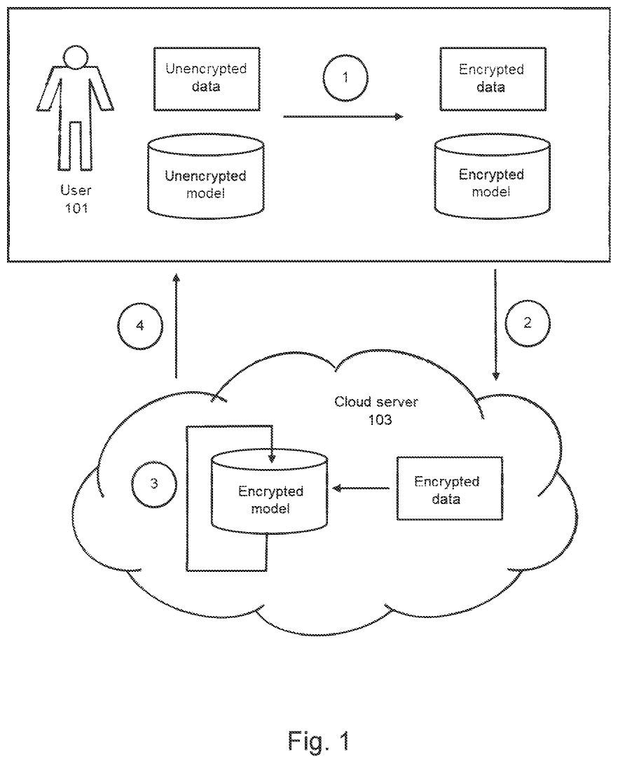

Embodiments of the invention will now be described by way of example with reference to FIG. 1, which shows a sequence of steps carried out in an embodiment.

### DETAILED DESCRIPTION

In embodiments described herein, a set of modifications are proposed to a machine learning model such as a CNN, in order to facilitate a number of advantages, including one or more of the following:

(i) The machine learning model can be trained using encrypted training data, either locally or externally (i.e. by a third party). Thus, the content of the training data need not be disclosed to the party carrying out the training.

(ii) Training of the machine learning model can be outsourced to a third party without that third party becoming privy to the content of the internal parameter values used in the model.

(iii) The machine learning model can be used to classify encrypted sets of data either locally or by outsourcing of the classification to a third party. Thus, the content of the data being classified need not be disclosed to the party carrying out the classification.

(iv) The use of the machine learning model (e.g. for classifying of data) can be outsourced to a third party without that third party becoming privy to the content of the internal parameter values used in the model or of the results of applying the model.

Embodiments facilitate the above functionality by utilising the technique of Homomorphic Encryption (HE). At a high level, HE enables one to perform computations on encrypted data. For example, one could add an encryption of “1” to an encryption of “4”, and then decrypt the resulting ciphertext to obtain “5”.

Embodiments described herein recognise the fact that machine learning models may often contain functions that are not compatible with HE i.e. functions for which there does not exist a practical means for implementing the function using an HE scheme. A lack of practical means may mean that it is not possible to compute the function, or else that it may be (mathematically) possible to do so but the computational cost in doing so will be such as to make the process untenable. Examples of functions that can be considered “non-HE-compatible” in this context include the following:

(i) Non-polynomial functions, such as ex, which can't be computed directly on a computer. These can be approximated with a (HE-compatible) polynomial on a computer.

(ii) Functions such as the ReLU function as used in a neural network, for example, and which have conditions. Where functions contain conditional statements (e.g. “IF” statements) or comparison statements, it may be possible to evaluate the function exactly in an HE scheme by transforming the function in a way that removes the conditions, but the computational cost involved in doing so will be too high for many applications.

(iii) Divide and square root operations, which require an algorithm on a computer to implement them. Note that the square root function, X^{I/2} is a polynomial, as is a division function x^{-I}. Such polynomial functions can be considered as being non-HE-compatible as they include non-integer or negative powers.

Embodiments described herein seek to replace such “non-HE compatible” functions with alternative functions that can be evaluated in an HE scheme with a manageable cost in terms of computational time and power. This is achieved by replacing functions not compatible with HE in the layers of the model with respective polynomial functions that will provide an approximation of those functions, and which can be implemented in an HE scheme whilst still providing an acceptable result in terms of accuracy. By doing so, a machine learning model can then be applied to cases in which it is desired to keep the internal parameters of the model and/or input data private, such as where it is desired for a third party (e.g. cloud server) to train the model on encrypted images without learning the input data and/or the sensitive trained parameters of the model, for example.

As used herein, the term “HE compatible” will be understood to refer to a model or algorithm where the functions for which there does not exist a practical means for implementing the function using an HE scheme have been substituted by appropriate polynomial functions. More specifically, an “HE-compatible” function can be considered to be a function which is a polynomial and whose powers are positive integers. Such functions are the only functions that can be immediately implemented using only addition and multiplication operations.

FIG. 1 shows a schematic of steps carried out according to an embodiment. Here, a user 101 has a model (machine learning algorithm) for performing a particular task such as classifying images, for example. The user has training data with which to train the internal parameters of the algorithm, but wishes to outsource training to a cloud server 103 (it will be appreciated that the training data may be owned by the model owner, or may be provided by a third party). It is desirable that the cloud server should not have access to the underlying data, or unencrypted model parameters. In order to achieve this, the user carries out the following steps:

1. The user encrypts the data using a HE public key. The user also replaces any layers in the model that are not compatible with HE with ones that are HE-compatible, by replacing one or more functions with polynomial functions that will provide an approximation of those functions. The user may choose a HE-compatible optimisation solver, such as the HE-compatible Adam solver discussed in more detail below. In one example, the user implements the relevant layers of the model using an HE library, such as HELib (the choice of library is likely to be dependent on the model being considered). This will include replacing additions and multiplications with HE additions and multiplications, respectively. It will also include adding bootstrapping operations in the implementation if required, in order to ensure that any ciphertext will correctly decrypt after the model has been applied. The user encrypts the (untrained) parameters of the model using a HE public key. These parameters may include, for example, the weightings applied at respective inputs to each layer and/or values of constants used in the functions executed within each layer.

2. The user transmits the HE model implementation, encrypted weights and encrypted training images to a third party server, over a communications network, for example. The user may also provide the HE-compatible optimization solver and any HE parameters required by the HE implementation. Additionally, the user may specify how many iterations/epochs for which to run the HE training procedure.

3. The third party server trains the encrypted weights of the HE model by applying the model to the encrypted training images.

4. The third party server returns the encrypted (trained) weights of the model to the user. The user then decrypts the trained weights to retrieve the model.

By virtue of the above steps, it is possible for the user 101 to recover a fully trained version of the model, without the need for that user to carry out the computationally intensive process of actually training the model. Meanwhile, the party charged with training the model (in this case, the cloud server 103) is unable to recover the underlying data and/or internal parameters in the model, thereby ensuring that the data and the values of those parameters are known only to the user.

In the example embodiment shown in FIG. 1, both the training data and the internal parameters of the model are encrypted. However, it will be appreciated that it is not essential to encrypt the internal parameters in all cases, nor is it essential that the training data should be encrypted. This can be understood as follows.

First, it will be recognised that there is an inherent benefit in modifying the model such that each layer is HE-compatible, in that the model can then be trained using encrypted data, as well as unencrypted data. Since the model can be trained using encrypted data, parties that would not otherwise wish to provide their data for training may now do so, secure in the knowledge that the actual content of that data will not be disclosed when training the model. Accordingly, it may be possible to source training data from a greater variety of sources. As an example, a health authority may consent to patients' data being used for training the model, on the basis that the patients' data is encrypted and will remain so throughout the duration of the training process.

It will further be recognised that the ability to train the model on encrypted training data will be present regardless of whether or not the internal parameters of the network are also encrypted. Thus, in the event that the model is to be trained locally, such that third parties will not have the opportunity to learn the internal parameter values used in the model, the model may be trained on the encrypted data without the need to also encrypt the internal parameter values. Meanwhile, if the model owner is actually not concerned about the values of the internal parameter values being disclosed to third parties, then training of the model (using the encrypted training data) can also be outsourced to a third party, again without the need to encrypt the parameters of the model.

in other scenarios, where the model owner desires to keep the internal parameters of the model secret, it will be necessary to encrypt the internal parameters of the network, but this does not necessitate the use of encrypted training data for training the model; training can still proceed using unencrypted data, with the values of the internal parameters being made known to the model owner alone, once training is complete.

In summary, although the ability to train the model using encrypted data and the ability to keep the values of the internal parameters secret both derive from the modifications made to the layers of the model, these are distinct features and can be implemented independently of one another, depending on circumstance.

Moreover, whilst the above discussion has focused on the training phase, it will also be appreciated that the same applies when actually using the trained model to perform its intended task (for example, using a trained CNN to perform classification of images not contained within the training sets). Here again, the data to be processed (classified) may be encrypted, without the party performing the classification being exposed to its actual contents. In addition or alternatively, if the internal parameters of the model have been encrypted, then a third party may use the model to classify both encrypted and/or unencrypted input data without that party becoming aware of the sensitive values of those (trained) internal parameters or the output of the ML algorithm

Training of the model can be implemented on a CPU, although in practice, training will usually be carried out on a GPU, in order that the training should be completed within a reasonable time frame. HE libraries with GPU support exist.

In some embodiments, the training data may comprise text, audio such as spoken utterances, or video, with the model outputting a score or classification for the data. Thus, the model may form part of a larger system, such as a speech synthesis system, image or video processing system, dialogue system, auto-completion system, or text processing system, for example. In each case, the output from the model may be used in executing a particular task, for example by generating a command used to cause an agent, such as a robotic device, to perform some type of action. For example, the model may be used as part of an image classification system in an autonomous vehicle, wherein the output from the model is used in determining whether an image of the road ahead includes an obstruction. In the event the model determines that such an obstruction is present, a command may be sent to the vehicle's steering system to manoeuvre the vehicle so as to avoid the obstruction.

In what follows, the methodology for replacing layers in the model will be explained in connection with a CNN, although it will be appreciated that the same method steps are applicable to other types of machine learning model, such as Support Vector Machines, Logistic Regression etc. as well as more general algorithms that need to be made HE-compatible.

In a first step, a determination is made as to which layers within the model are required to be modified in order that the model may be made compatible with an HE scheme. Inone example, the layers of the CNN that are identified as requiring modification are as follows:
ReLU layer
Average and Max Pooling layers
Softmax layer
Batch Normalization layer

Training a CNN also typically requires use of an optimization solver, such as the Adam optimization solver. Such solvers, including the Adam solver, are often not HE-compatible, hence it is desirable to provide a means for approximating popular solvers so that they can be used in a HE CNN implementation.

In the next step, those layers whose nodes perform computational functions that are not compatible with HE are modified by replacing their functions with alternative computational functions that will, to a good approximation, provide the same or similar output given a respective set of inputs. Some layers may require careful parameter selection in order to achieve good classification accuracy for the model in which they are used.

The specific layers will now be addressed in turn.

1. Softmax Layer

The Softmax layer is very commonly used in CNNs during the training phase. In order for the Softmax layer to be implementable using HE, it is necessary to replace instances of the exponential function ex in the Softmax layer with HE-compatible alternatives. One possibility for doing so is through a Taylor Series polynomial approximation of ex in the Softmax layer. It is further necessary to replace square roots and division operations in the Softmax layer with HE-compatible alternatives, in order to make the Softmax layer HE-compatible. An example of how this can be achieved is by using the Newton-Raphson method for approximating square roots and inverses (division) in the Softmax layer.

When modifying the Softmax layer, training errors may occur due to integer overflow errors; the application of weights in a neuron may cause the result to be too big for the HE scheme to handle, since HE schemes have a fixed maximum plaintext value once their parameters have been set. Applying a Batch Normalisation layer before the HE-compatible Softmax layer can help to fix this problem by ensuring that inputs to approximations are in the right interval at which the approximation functions best approximate the original functions. Batch Normalisation layers may also be used before other layers in a HE-compatible CNN in order to prevent integer overflow errors occurring in other layers.

2. Batch Normalisation Layers

Batch Normalisation layers require the computation of square roots and division operations which are not supported by HE. Here again, a Newton-Raphson method for approximating square roots and inverses may be implemented in order to make the Batch Normalisation layers in the CNN HE-compatible.

3. Optimisation Solvers

The Adam Optimisation Solver is a popular tool used to improve the training of a CNN. As in the case of the Softmax layer and Batch Normalisation layers, the Adam Optimisation Solver involves computing square roots and division operations which are not supported by HE. The Newton-Raphson method for approximating square roots and inverses can be implemented in the Adam Optimisation Solver, as well as other non-HE-compatible Optimisation Solvers, such as the Adagrad Solver. Certain divisions and square roots in the Adam Optimisation Solver may also be computed ahead of time, HE-encrypted, and then used as and when required.

4. Loss Function

The Categorical Cross Entropy (CCE) loss function is a popular loss function commonly used in a CNN's training phase. The CCE loss function contains logarithms that cannot be implemented directly using HE operations. A Taylor Series approximation of log(x) and log(1-x) can be implemented in the Categorical Cross Entropy (CCE) loss functions (in both the binary and multi-class versions) in order to make the loss functions HE-compatible.

5. ReLU Function

The ReLU function is a popular non-linear layer commonly used in CNNs that is not HE-compatible. In this instance, a Taylor Series approximation of the Softplus function can be used to approximate the ReLU function in a HE-compatible CNN. The Taylor Series approximation of the Softplus function may be implemented with different degrees of approximation; in some instances, a degree four approximation can provide an effective result. A further option is the use of Chebyshev polynomial approximations of the ReLU function.

In order to assess the performance of a machine learning model implementing features of the described embodiments, experiments were conducted using an example CNN comprised of twenty layers in which all non-HE-compatible layers were made HE-compatible, and in which each modified layer was optimised in order to improve the classification accuracy of the CNN. Classification accuracies for the different variants were as follows:

(i) Classification accuracy for a CNN without any HE modifications, trained and used to classify images without the use of HE (i.e. both the model and data are unencrypted): 88%

(ii) Classification accuracy for a CNN after making necessary layers HE-compatible so that it can be directly implemented using HE and used to classify images using HE (but where training is performed in unencrypted form without HE): 80%

(ii) Classification accuracy for a CNN after making all layers and the Optimisation solver HE compatible: 80%.

It will be appreciated that backpropagation supports HE operations when the (training) CNN is completely HE-compatible. Backpropagation will, however, only work if all layers in the model including the loss function are made HE-compatible. Hence, in order to outsource the training of the model to a third party, the model must include an HE-compatible loss function. Accordingly, in cases where it is desired to implement backpropagation, the replacement of a (non HE-compatible) loss function with a HE compatible loss function will play an important role in allowing the third party to train the model without its becoming aware of the underlying parameter values.

In some embodiments, the performance time for training and classification using the HE-compatible CNN can be improved in a HE implementation through increasing the batch size and reducing the number of training epochs (iterations). As the number of iterations required to complete one epoch is equal to the total number of training images divided by the batch size, reducing the number of training images or number of epochs, or increasing the batch size should lead to an improvement in performance time. Reducing the number of iterations is particularly helpful in terms of reducing the “bootstrapping” time, bootstrapping being a procedure often required in HE implementations which is computationally expensive. Reducing the batch size and/or increasing the number of iterations can affect the accuracy of the trained model; thus, these parameters can be tuned to obtain a desired balance between the time taken to train the model and the accuracy of the model.

It will be appreciated that, in order to enhance the accuracy of the HE-compatible CNN, additional steps may be taken once all layers have been made HE-compatible. For example, there may be several choices of modification for some layers, some of which may perform better than others depending on the nature of the input. Accordingly, some layers may require careful parameter selection, and where changes are made in a particular layer, these changes may influence the choice of how to modify other layers in the model so as to make those layers HE compatible. It may be desirable to add additional layers in the network in order to improve accuracy of the HE-compatible layers.

Embodiments can be implemented using a (Fully) HE library (or an implementation of aHE scheme). For example, the invention can be implemented using a HE library called HEAAN, as known in the art.

Embodiments can also be applied to other machine learning algorithms (e.g. logisticregression) in order to support training using HE. In particular, the method used to approximate division could be used in other machine learning algorithms.

Alternative polynomial approximations may be used to approximate some of the non-linear CNN layers. Although the above described embodiments include the use of the Newton-Raphson method for approximating division, it will be appreciated that alternative functions for approximating division, as known in the art, may also be used.

Embodiments provide an alternative to MPC solutions to achieve private learning, and are applicable in alternative system architectures in which MPC solutions are sub-optimal or not feasible. In particular, embodiments only require one entity to train the network, and do not require interaction between multiple parties during training.

In summary, embodiments described herein:
support training using HE
support classification using HE
are not model/dataset dependent
do not require an unencrypted training phase first
provide a complete solution on how to train a machine learning model using HE.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

While certain embodiments have been described, these embodiments have been presented by way of example only and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

1. A computer-implemented method for training a machine learning model, the method comprising:
obtaining a machine learning model comprising a plurality of computational layers, the layers being arranged such that outputs from one or more of the layers serve as inputs to other ones of the layers;
identifying one or more of the layers as comprising one or more functions that are not compatible with a homomorphic encryption scheme;
replacing the one or more functions with alternative functions, wherein the alternative functions are functions that are compatible with the homomorphic encryption scheme and which provide an approximation of the respective functions that they replace; and
sending the model to a third party to train the model using a set of training data.

2. The computer-implemented method according to claim 1, wherein the one or more functions that are not compatible with the HE scheme include one or more of:
(i) A non-polynomial function;
(ii) A function including one or more conditional statements; and
(iii) A polynomial function that includes a non-integer and/or negative power.

3. The computer-implemented method according to claim 1, wherein the alternative functions comprise polynomial functions whose powers are positive integers.

4. The computer-implemented method according to claim 1, comprising:
encrypting internal parameters of the model with a public key of the homomorphic encryption scheme prior to sending the model to the third party.

5. The computer-implemented method according to claim 4, further comprising:
receiving a trained version of the machine learning model from the third party; and
decrypting the internal parameters of the trained version of the machine learning model using the private key of the homomorphic encryption scheme.

6. The computer-implemented method according to claim 4, wherein the internal parameters of the model comprise one or more of:
(i) constants comprised within the functions of the model and
(ii) weightings applied to input(s) to each layer of the model.

7. The computer-implemented method according to claim 4, wherein the training data comprises encrypted data.

8. The computer-implemented method according to claim 4, wherein sending the model to the third party comprises transmitting the model as data over a communications network.

9. A computer-implemented method for training a machine learning model, the method comprising:
obtaining a machine learning model comprising a plurality of computational layers, the layers being arranged such that outputs from one or more of the layers serve as inputs to other ones of the layers;
identifying one or more of the layers as comprising one or more functions that are not compatible with a homomorphic encryption scheme;
replacing the one or more functions with alternative functions, wherein the alternative functions are functions that are compatible with a homomorphic encryption scheme and which provide an approximation of the respective functions that they replace;
receiving encrypted training data for training the machine learning model; and training the model using the training data.

10. The computer-implemented method according to claim 9, wherein the one or more functions that are not compatible with the HE scheme include one or more of:
(i) A non-polynomial function;
(ii) A function including one or more conditional statements; and
(iii) A polynomial function that includes a non-integer and/or negative power.

11. The computer-implemented method according to claim 9, wherein the
alternative functions comprise polynomial functions whose powers are positive integers.

12. The computer implemented method according to claim 9 wherein the training data comprises data that is encrypted by a third party.

13. The computer-implemented method according to claim 9, comprising using the trained machine leaning model to carry out a machine learning task.

14. The computer-implemented method according to claim 13, wherein the step of using the trained machine learning model to carry out the machine learning task is performed by a third party.

15. The computer-implemented method according to claim 14, wherein the task comprises classification of one or more images.

16. The computer-implemented method according to claim 14, wherein the machine learning model is a neural network.

17. The computer-implemented method according to claim 16, wherein the machine learning model is a convolutional neural network.

18. The computer-implemented method according to claim 14, wherein replacing the functions with alternative functions includes selection of an optimisation solver that is compatible with homomorphic encryption.

19. The computer-implemented method according to claim 14, wherein the functions to be replaced comprise one or more functions having one or more division operations and/or which contain one or more square roots.

20. The computer-implemented method according to claim 19, wherein the functions having one or more division operations and/or which contain one or more square roots are replaced by using a Newton-Raphson method to approximate the square root(s) and/or divisions.

21. The computer-implemented method according claim 20, wherein the functions to be replaced comprise one or more exponential functions.

22. The computer-implemented method according to claim 21, wherein the exponential functions are replaced by using a Taylor series approximation of the exponential function(s).

23. The computer-implemented method according to claim 14, comprising adding a batch normalisation layer before one or more of the layers whose functions have been replaced by alternative functions.

24. A computer-implemented method according to any one of the preceding claims, wherein the functions to be replaced include a loss function used in training the model.

25. A computer-implemented method according to any one of the preceding claims, wherein the model is trained using backpropagation.

26. A computer readable medium comprising computer executable code that when executed by the computer will cause the computer to carry out a method according to any one of the preceding claims.
